(19) United States
(12) Patent Application Publication
(10) Pub. No.: US 2007/0164620 A1
(43) Pub. Date: Jul. 19, 2007

(54) Device for arranging connections and method for application of said device

(75) Inventors: Francis Bidaud, Epinay Sur Duclair (FR); Jean-Jacques Routier, Ste Marguerite Sur Duclair (FR); Daniel Cappoen, La Vaupaliere (FR); Claude Collet, Croix Mare (FR)

Correspondence Address: LOWE HAUPTMAN GILMAN & BERNER, LLP, 1700 DIAGNOSTIC ROAD, SUITE 300, ALEXANDRIA, VA, 22314, US

(73) Assignee: Tecumseh Europe S.A., La Verpilliere (FR)

(21) Appl. No.: 10/556,796

(22) PCT Filed: May 13, 2004
(86) PCT No.: PCT/EP04/50791

§ 371 Date: Nov. 21, 2006

(30) Foreign Application Priority Data
May 16, 2003 (FR) 03 05906

(51) Int. Cl. H02K 11/00; H02K 15/00

(52) U.S. Cl. 310/71; 29/596

(57) ABSTRACT

The invention relates to a device for connecting an end (4) of at least one winding wire of a fixed winding (2) and an end (8) of at least one supply wire supplying power to the winding (2). The device comprises non-removable electrical-connection means (7) for connecting the end (4) of the single-strand wire and the end (8) of the multi-strand wire, and a storage case (10) for storing the connecting means (7). The invention also relates to a method for implementing the device, consisting in:
storing the connecting means (7) in the storage case (10),
then closing the storage case (10).

The invention relates to a device for connecting the wires of one or more windings that make up the fixed part of an electrical machine and are known as “winding wires” and wires connected to an external source of electrical power, known as “supply wires”. Hereinafter, a winding constituting the fixed part of an electrical machine will be termed the fixed winding. The invention also relates to a method for implementing the device.

The invention finds a particular although not exclusive use in connecting the winding wires of the stator of an electric motor to the stator supply wires. The invention can be implemented for connection to supply wires of any fixed part of an electrical machine such as, for example, the winding of a transformer or the stator of a generator.

In general, the winding wires and the supply wires are of different kinds. More specifically, the winding wires are generally single-strand wires covered with insulation, such as enamel for example. These winding wires are commonly known as “enameled wires”. The supply wires may be multi-strand wires and may be coated with a flexible sheath, such as a braided polyester sheath for example. The winding wires and the supply wires may have different cross sections. Furthermore, several winding wires may be connected to one and the same supply wire and vice versa. In order to make this connection, electrical connections are made between the two types of wire. These connections need to be insensitive to external forces such as vibrations amongst other things. In order to ensure their mechanical integrity, these connections are mechanically secured to the stator.

Several embodiments have been used to connect the winding wires and the supply wires.

A first embodiment has been to provide non-removable means of connection connecting the supply wires and the winding wires, such as soldering or crimping a conducting sleeve onto the stripped ends of the supply wires and of the winding wires. The connection thus made is then insulated, for example using an insulating sleeve, then fixed to or into the stator winding, for example by means of a lacing around the winding.

This first embodiment has several disadvantages. For example: when the windings have to be shaped by pressing in order to observe dimensions defined by a technical specification, it can happen that, during this operation, the connection punctures the insulation under the effect of the pressure and damages the winding wire or the supply wire. Another disadvantage occurs when the windings have to be impregnated with lacquer, and when the supply wires are coated with a flexible sheath. The lacquer can diffuse into the flexible sheath through a capillary effect, and, when it dries, give it a rigidity that is detrimental to assembly. Furthermore, the volume represented by the supply wires and the connections occupy some of the “active” volume consisting of the windings themselves, and this may present disadvantages in terms of stator size. In addition, in the case of large-sized motors provided with very stiff wires, it is difficult to make the connections. This may give rise to occupational injuries such as tendonitis amongst the operators making these connections.

Another embodiment has been to use a removable connector formed of two elements that plug together. One of these elements is usually a socket secured to the stator and connected to the winding wires. The other element is usually a plug connected to the supply wires. The connector may comprise crimped or self-stripping pins connected to the winding and supply wires. Connection is made when the two elements are plugged together.

This second embodiment also exhibits several disadvantages. For example: the choice of connectors, particularly the choice of pins, is connected with the cross sections of the winding and supply wires, which cross sections in order to be able to be connected cannot differ too greatly. In other words, one and the same connector can be used only for winding or supply wires the cross sections of which lie within a specific and generally somewhat narrow range.

Furthermore, in certain applications, it is necessary to position the supply wires very accurately in space. The removable connectors, purchased commercially, generally do not provide positioning means suited to a stator.

Furthermore, when such a connector is installed inside a piece of equipment which is difficult to access, it is difficult for an operator to plug the two elements together because of the absence of guidance of one element with respect to the other.

In addition, amongst windings and connections, the winding wires, generally single-strand wires, emerge from the winding and are therefore delicate. The two embodiments described hereinabove provide neither mechanical protection nor electrical insulation for the winding wires.

It is the object of the invention to alleviate the disadvantages of the embodiments described above. To this end, the subject of the invention is a device for connecting an end of at least one winding wire of a fixed winding and an end of at least one supply wire supplying power to the winding, the device comprising non-removable electrical-connection means for connecting the end of at least one winding wire and the end of at least one supply wire, characterized in that it further comprises a storage case for storing the connecting means.

Another subject of the invention is a method implementing the device described above, the method consisting in: storing the connecting means in the storage case, then closing the storage case.

The invention will be better understood and other advantages will become apparent from reading the detailed description of one embodiment, given by way of example, the description being illustrated by the attached drawing in which:

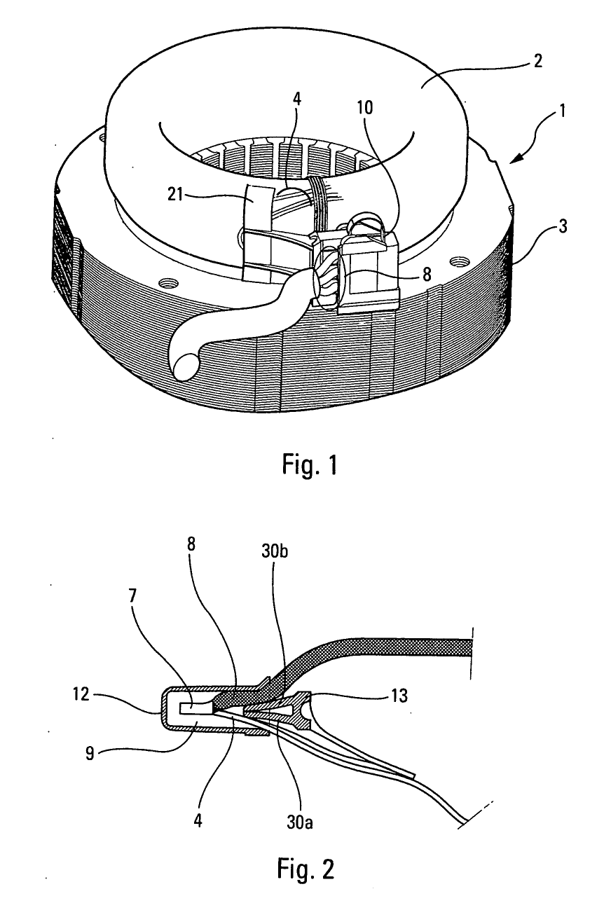

FIG. 1 depicts a storage case mounted on a stator of an electric motor;

FIG. 2 depicts the inside of a storage case, the connecting means and the two protrusions which retain the connecting means;

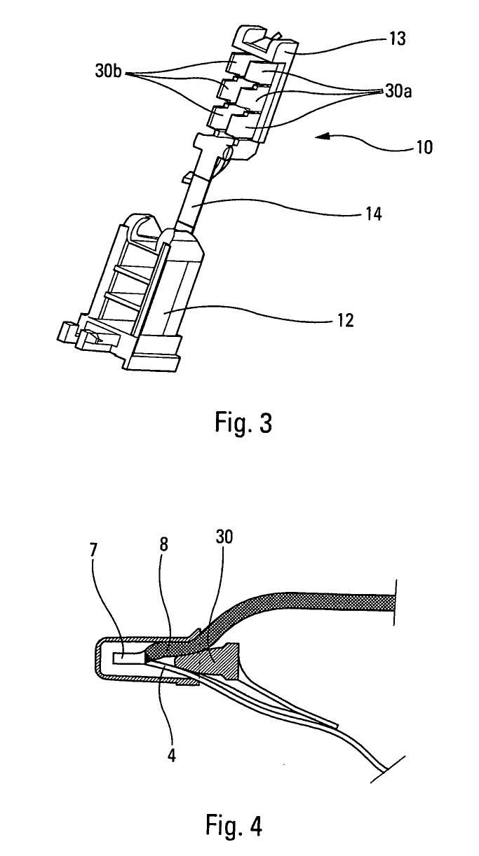

FIG. 3 depicts a storage case comprising two rows of protrusions for retaining the connecting means in the storage case;

FIG. 4 depicts a variant of the invention showing the inside of a storage case comprising just one protrusion holding the connecting means in the storage case;

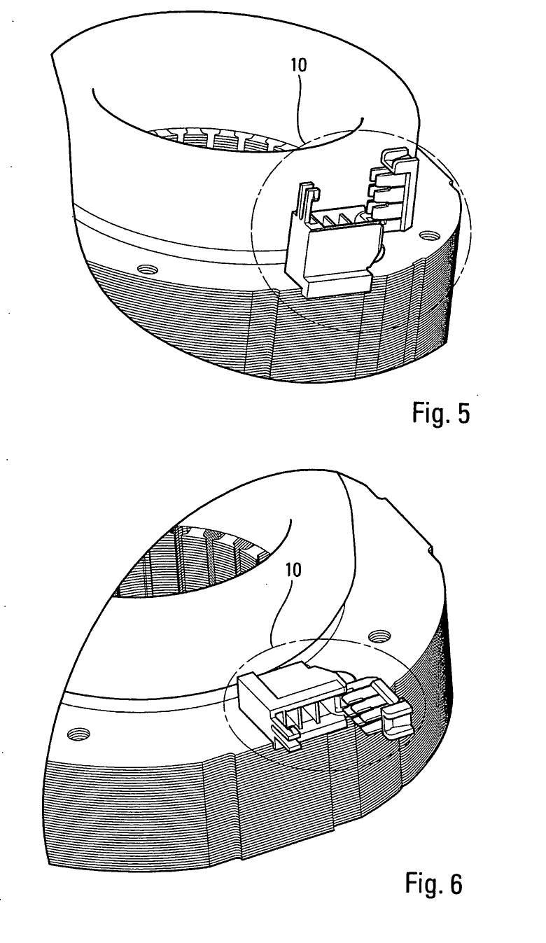

FIGS. 5 and 6 depict two variants of a storage case which are mounted in two different positions from the position of FIG. 1 on a stator of an electric motor;

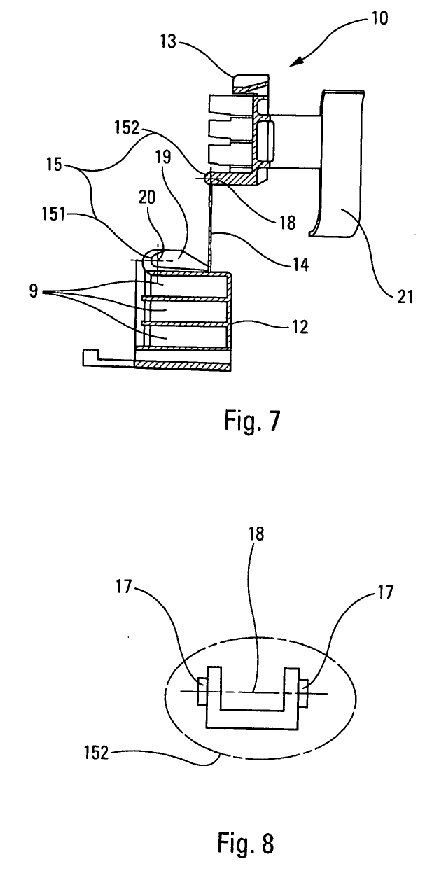

FIG. 7 depicts a storage case in the open position;

FIG. 8 depicts part of the articulation of a storage case;

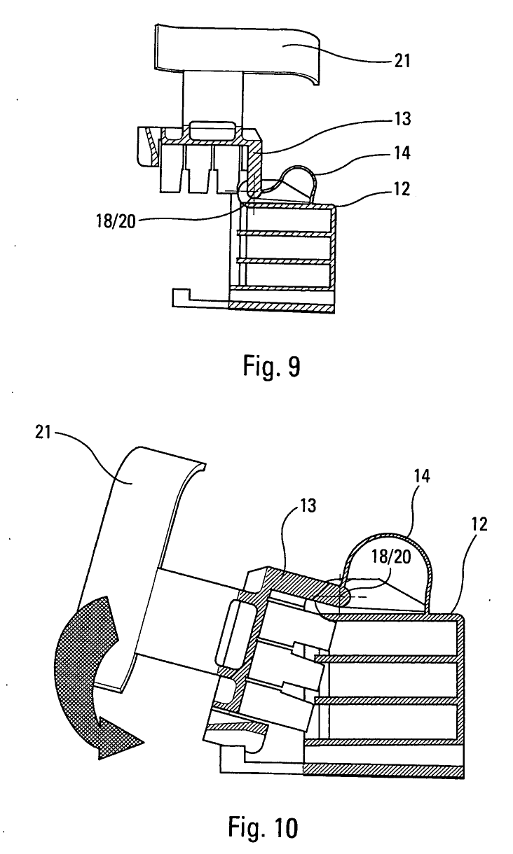

FIGS. 9 and 10 depict a storage case in a semi-open position;

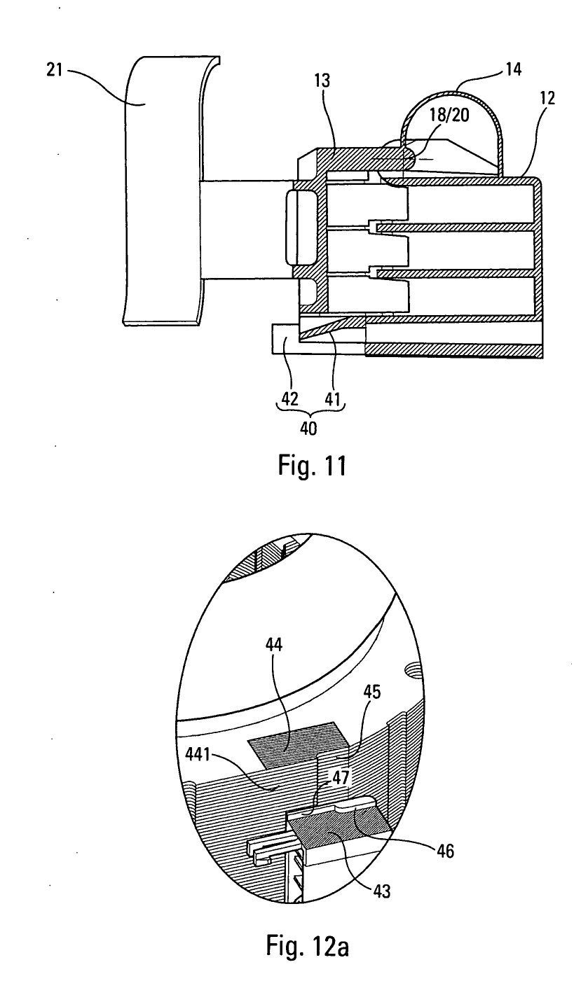

FIG. 11 depicts a storage case in the closed position;

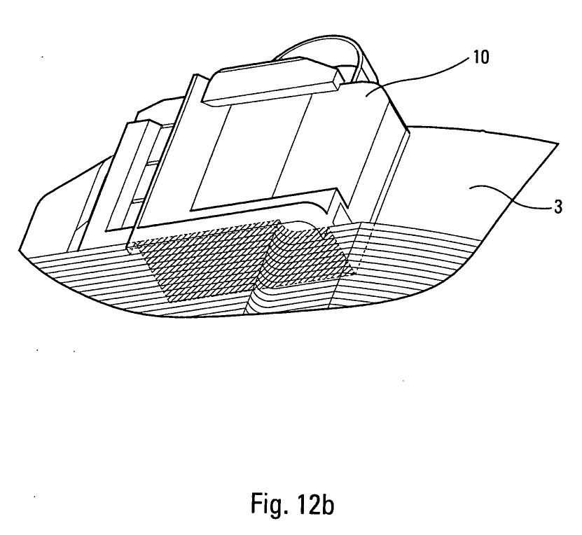

FIG. 12a depicts a storage case before it is fitted on the stator and means intended to be indexed in the position of the storage case with respect to a stator;

FIG. 12b depicts the storage case depicted in FIG. 12a, mounted on the stator.

To make the description easier to understand, the same elements will bear the same references in the various figures.

FIG. 1 depicts a storage case 10 mounted on a stator 1 of an electric motor.

The stator 1 comprises a bundle of laminations 3, windings 2, from which the ends 4 of wires forming the windings 2 emerge. The ends 4 of winding wires are connected to ends 8 of supply wires. In FIG. 1, three ends 4 and three ends 8 have been depicted. Of course, the invention is not restricted to the connecting of three winding wires with three supply wires. The invention can be implemented irrespective of the number of ends of wires to be connected.

Non-removable electrical-connection means 7 clearly visible in FIG. 2 allow the end 4 of at least one winding wire to be connected to an end 8 of at least one supply wire. The connecting means 7 advantageously comprise a conducting sleeve which will also bear the topological reference 7. The sleeve 7 is crimped both onto the stripped end 4 of at least one winding wire and onto the stripped end 8 of at least one supply wire.

More specifically, the sleeve 7 is formed of a tube a few millimeters long made of a soft metal and in which the stripped ends 4 and 8 of the winding and supply wires that are to be connected are positioned. The sleeve 7 is then deformed using crimping pliers until the stripped ends 4 and 8 are pinched together in order to ensure that they make good electrical contact with one another.

The sleeve 7 is placed in a cavity 9 of the storage case 10. The storage case 10 is made of an insulating material so that it electrically insulates the sleeve 7. Unlike one of the embodiments described above, in which embodiment a conducting sleeve, covered with an insulating sleeve, is placed in the lead-out of a winding, the fact of making the storage case 10 from an insulating material makes it possible to dispense with this insulating sleeve covering the sleeve 7, the conducting material of which can remain bare, that is to say not electrically insulated.

The use of a crimped sleeve 7 is not the only alternative to the electrical connection of the winding wires and the supply wires. It is, for example, possible to solder at least one winding wire and at least one supply wire together.

Advantageously, the storage case 10 comprises a body 12 and a lid 13. The lid 13 holds the electrical-connection means 7 inside the body 12. The sleeve 7 is then immobilized in the storage case 10 and only insulated parts of the winding and supply wires are visible outside the storage case 10.

In the embodiment variant depicted in FIGS. 2 and 3, the retaining means for holding the electrical-connection means 7 comprise two protrusions 30a and 30b which fit between the end 4 of the winding wire and the end 8 of the supply wire inside the body 12. A first protrusion 30a holds the end 4 of the winding wire and a second protrusion 30b holds the end 8 of the supply wire. The two protrusions 30a and 30b belong to the lid 13. The protrusions 30a and 30b deform when the storage case 10 is closed and by an elastic effect immobilize the ends 4 and 8 against walls of the storage case 10.

In another embodiment variant depicted in FIG. 4, the retaining means for holding the electrical-connection means 7 comprise a protrusion 30, belonging to the lid 13, and fitting between the end 4 of the winding wire and the end 8 of the supply wire inside the body 12.

The embodiment variant depicted in FIGS. 2 and 3 has the advantage that it can adapt to suit different cross sections of wires the ends of which are connected inside the storage case 10. It is, for example, possible to connect wires the cross sections of which vary by factors of three or more. This is an advantage if it is desired to use the same storage case 10 on several different electric motors. This storage case 10 then becomes a standard mechanical component, thus reducing its cost of production. The other embodiment variant depicted in FIG. 4 also has this advantage over the prior art when one connector is used, but to a lesser extent.

In the embodiment depicted in the various figures, the storage case 10 comprises three cavities 9. It is, of course, possible to produce a storage case according to the invention comprising a different number of cavities 9, according to the number of separate connections to be made.

FIG. 5 depicts a variant for the positioning of the storage case 10 relative to the stator winding 2. In this variant, the storage case 10 is positioned in such a way that the compartment or compartments 9 open more or less parallel to the main axis of the stator winding 2.

FIG. 6 depicts another variant for the positioning of the storage case 10 with respect to the stator winding 2. In this variant, the storage case 10 is positioned in such a way that the compartment or compartments 9 open more or less perpendicular to the main axis of the stator winding 2.

The orientation of the opening of the compartments 9 is chosen according to the ease of access to the interior of the electric motor comprising the storage case 10.

Advantageously, the storage case 10 is formed of a single mechanical component produced by molding. The storage case 10 is depicted in section in FIG. 7. The storage case 10 comprises a flexible part 14 connecting the body 12 and the lid 13. Thus, the body 12 and the lid 13 can be manipulated one with respect to the other without them becoming detached. When the storage case 10 is fixed on the bundle of laminations 3, the lid 13 is captive with respect to the stator 1 of the electric motor. The storage case 10 depicted in FIG. 7 comprises three cavities 9 and a sleeve 7 is introduced into each of them.

To make the lid 13 easier to close with respect to the body 12, the case 10 has an articulation 15 articulating the lid 13 with respect to the body 12. The articulation 15 makes it easier to fit the sleeves 7 in the cavities 9. An operator can thus hold the cables 8 in one hand in order to keep the sleeves 7 in the cavities 9, and close the lid 13 with the other hand, by pivoting the lid 13 about the articulation 15.

More specifically, the articulation 15 comprises a first part 151 belonging to the body 12 and a second part 152 belonging to the lid 13. FIG. 8 depicts the part 152 of the articulation 15 viewed in a plane perpendicular to that of FIG. 7. The part 152 comprises two fingers 17 extending along an axis 18. When trying to close the lid 13 onto the body 12, the fingers 17 are inserted in grooves 19, belonging to the body, and complementing the fingers 17. The axis 18 of the fingers 17 then more or less comes into coincidence with an axis 20 of the body 12. The articulation 15 pivots about the coincident axes 18 and 20.

The pivoting of the articulation 15 is illustrated by means of FIGS. 9, 10 and 11 where three positions are depicted. In FIG. 9, the lid 13 is in a semi-open position with respect to the body 12. In FIG. 11, the lid 13 is in a closed position with respect to the body 12. FIG. 10 depicts an intermediate position between the positions of FIGS. 9 and 11.

Advantageously, the case 10 comprises means for locking the lid 13 with respect to the body 12. In a preferred configuration of the invention, the locking means comprise a clip 40 formed of two complementing parts 41 and 42 belonging one to the body 12 and one to the lid 13, respectively, as depicted in FIG. 11.

Advantageously, the storage case 10 comprises means for positioning it with respect to the bundle of laminations. For this, the body 12 comprises, for example, as depicted in FIG. 12a, a planar face 43, an elongate lip 47, and an end stop 46. The lip 47 and the end stop 46 protrude with respect to the planar face 43 so that the storage case 10 is fully positioned with respect to an element on which it is placed. In other words, six degrees of freedom of the storage case 10 with respect to the stator 1 are eliminated. The bundle of laminations 3 comprises shapes that complement the planar face 43, the lip 47 and the end stop 46, namely two planar faces 44 and 441 and a step 45 against which the planar face 43, the lip 47 and the end stop 46 respectively bear. The two planar faces 44 and 441 and the step 45 are, for example, mutually perpendicular.

FIG. 12b depicts the storage case 10 in position with respect to the bundle of laminations 3. It can be held in the position thus defined by an adhesive suited to the material of the contacting parts, that is to say to the material of the storage case 10 and to the material of the laminations that form the bundle 3. The adhesive needs also to be suited to the environmental conditions to which the electric motor is subjected.

Advantageously, the connecting device comprises retaining means 21 for holding the winding wire or wires pressed against the stator winding 2. More specifically, the retaining means 21 form a single mechanical component with the storage case 10. In the example depicted in the various figures, the retaining means 21 are formed of a tab made as one piece with the lid 13 of the storage case 10. The tab 21 has a more or less planar shape hugging the shape of the stator winding 2. The ends 4 of the winding wires emerging from the stator winding 2 are held between the winding 2 and the tab 21.

The device described above is advantageously implemented as follows:
store the connecting means 7 in the storage case 10,
then close the storage case 10.

More specifically, the method consists in:
storing the connecting means 7 in the compartment 9,
then fitting the articulation 15,
then pivoting the articulation 15 until the lid 13 is locked with respect to the body 12 by means of the clip 40.

The storage case 10 may be fixed to a bundle of laminations of the stator winding 2 before the connecting means 7 are stored or after the storage case 10 has been closed, depending on the ease of access to the inside of the electric motor.

Advantageously, the ends 4 and 8 are connected using the connecting means 7 before the connecting means 7 are stored in the storage case 10. This is achieved, for example, by crimping or soldering the ends 4 and 8 before storing the connecting means 7 in the storage case 10.

1-25. (canceled)

26. A device for connecting an end of at least one winding wire of a fixed winding and an end of at least one supply wire supplying power to the winding, the device comprising non-removable electrical-connection means for connecting the end of at least one winding wire and the end of at least one supply wire, a storage case for storing the connecting means, the storage case comprising a body and a lid, wherein the storage case comprises a flexible part connecting the body and the lid, wherein the storage case comprises an articulation articulating the lid with respect to the body, and wherein the articulation of the lid with respect to the body can be disassembled.

27. The device as claimed in claim 26, wherein the storage case electrically insulates the connecting means.

28. The device as claimed in claim 26, wherein the connecting means comprise a sleeve crimped onto the stripped end of the winding wire and onto the stripped end of the supply wire.

29. The device as claimed in claim 26, wherein the fixed winding is wound around a bundle of laminations and wherein the storage case is able to be fixed on the bundle of laminations.

30. The device as claimed in claim 29, wherein the storage case comprises means for positioning it with respect to the bundle of laminations.

31. The device as claimed in claim 30, wherein six degrees of freedom of the storage case with respect to the fixed winding are eliminated.

32. The device as claimed in claim 30, wherein the fixed winding has a main axis, wherein the storage case has at least one cavity, wherein the storage case is positioned in such a way that the cavity opens more or less parallel to the main axis.

33. The device as claimed in claim 30, wherein the fixed winding has a main axis, wherein the storage case has at least one cavity, wherein the storage case is positioned in such a way that the cavity opens more or less perpendicular to the main axis.

34. The device as claimed in claim 26, wherein the lid has retaining means for holding the electrical-connection means inside the body.

35. The device as claimed in claim 34, wherein the retaining means for holding the electrical-connection means comprise a protrusion that fits between the end of the winding wire and the end of the supply wire inside the body.

36. The device as claimed in claim 34, wherein the retaining means for holding the electrical-connection means comprise two protrusions which fit between the end of the winding wire and the end of the supply wire inside the body, a first protrusion holding the end of the winding wire and a second protrusion holding the end of the supply wire.

37. The device as claimed in claim 36, wherein the end of the winding wire and the end of the supply wire are immobilized inside the body by elastic deformation of the two protrusions.

38. The device as claimed in claim 26, wherein the body, the lid and the flexible part form a single mechanical component produced by molding.

39. The device as claimed in claim 26, wherein the articulation comprises two fingers belonging to the lid and two grooves belonging to the body, and wherein the grooves complement the fingers.

40. The device as claimed in claim 26, wherein the storage case comprises locking means for locking the lid with respect to the body.

41. The device as claimed in claim 40, wherein the locking means comprise a clip.

42. The device as claimed in claim 26, wherein it comprises means able to hold the winding wire pressed against the fixed winding.

43. The device as claimed in claim 42, wherein the retaining means are formed of a tab made as one piece with the lid, wherein the tab has a more or less planar shape hugging the shape of the fixed winding wherein, and wherein the ends of the winding wires are held between the fixed winding and the tab.

44. The device as claimed in claim 42, wherein the retaining means form a single mechanical part with the storage case.

45. The device as claimed in claim 26, wherein the storage case comprises several cavities each accepting the connecting means for connecting at least one winding wire and at least one supply wire.

46. A method for implementing a device for connecting an end of at least one winding wire of a fixed winding and an end of at least one supply wire supplying power to the winding, the device comprising non-removable electrical-connection means for connecting the end of the winding wire and the end of the supply wire, wherein the device further comprises a storage case for storing the connecting means, wherein the storage case comprises an articulation of the lid with respect to the body, wherein the articulation of the lid with respect to the body can be disassembled, and wherein the method comprises:
storing the connecting means in the storage case,
then closing the storage case.

47. The method as claimed in claim 46, wherein the storage case comprises a body, a lid, an articulation such that the lid can be disassembled from the body, locking means for locking the lid with respect to the body, at least one cavity, wherein the locking means comprise a clip, and wherein the method comprises:
storing the connecting means in the cavity,
then fitting the articulation,
then pivoting the articulation until the lid is locked with respect to the body by means of the clip.

48. The method as claimed in claim 46, wherein it consists in fixing the storage case to a bundle of laminations of the fixed winding before storing the connecting means.

49. The method as claimed in claim 46, wherein it consists in fixing the storage case to a bundle of laminations of the fixed winding after closing the storage case.

50. The method as claimed in claim 48, wherein it consists in fixing the storage case to a bundle of laminations of the fixed winding by bonding.

51. The method as claimed in claim 46, wherein an end of at least one winding wire of a fixed winding and an end of at least one supply wire are connected using the connecting means before the connecting means are stored in the storage case.
